(19) United States
(12) Patent Application Publication
(10) Pub. No.: US 2018/0022167 A1
(43) Pub. Date: Jan. 25, 2018

(54) TRUCK TIRE TREAD AND TRUCK TIRE

(71) Applicant: Compagnie Generale des Etablissements Michelin, Clermont-Ferrand (FR)

(72) Inventor: Stefan VOSS, Greer, SC (US)

(21) Appl. No.: 15/537,457

(22) PCT Filed: Dec. 9, 2015
(86) PCT No.: PCT/US2015/064673

§ 371 Date: Jun. 19, 2017

Related U.S. Application Data
(60) Provisional application No. 62/093,532, filed on Dec. 18, 2014.

(51) Int. Cl. B60C 11/03

(52) U.S. Cl. CPC B60C 11/0323; B60C 2200/06

(57) ABSTRACT

Heavy truck tire tread having a longitudinal direction, a transverse direction and a thickness direction, said tread having a ground engaging surface and comprising a series of similar tread features repeated along its longitudinal direction, each tread feature comprising: two ducts extending from the ground-engaging surface in the thickness direction, said ducts being apart one from the other and having a duct section area of at least 10 mm² and a length comprised between 50% and 100% of a thickness of said tread; one void being in fluidic connection with said two ducts, said void extending substantially parallel to the ground-engaging surface of the tread and at a distance therefrom and having a void section area of at least 10 mm; and one sipe joining said two ducts and said void; wherein said feature is otherwise blind and said series comprises 50 of said similar tread features.

### BACKGROUND OF THE INVENTION

### Field of the Invention

This invention relates generally to a tire tread. More specifically, this invention relates to tire treads for long haul heavy trucks, in particular tires for free-rolling wheels thereof (so called steer positions and trailer positions), especially tires for trailers or semi-trailers.

### Description of the Related Art

Tire treads generally extend about the outer circumference of a tire to operate as the intermediary between the tire and a surface upon which it travels (the operating surface). Contact between the tire tread and the operating surface occurs along a footprint of the tire. Tire treads provide grip to resist tire slip that may result during tire acceleration, braking, and/or cornering. Tire treads may also include tread elements, such as ribs or lugs, and tread features, such as grooves and sipes, each of which may assist in providing target tire performance when a tire is operating under particular conditions.

One common problem faced by tire manufacturers is how to extend the wear life of a tire tread.

One solution is to increase the tread thickness; however, increasing the tread thickness (i.e., depth) generally increases heat generation and rolling resistance. Increasing tread thickness also decreases tread stiffness which in turn increases initial wear rate. Increasing tread thickness is therefore not an efficient solution for improving wear life and therefore not the way to go.

Another solution is to increase the ratio of the tread surface being in contact with the operating surface. This ratio is known as the Contact Surface Ratio (CSR). Increasing the CSR is known to be beneficial for wear life and can be beneficial for rolling resistance too. However, increasing the CSR is also known for harming the wet braking adherence performance of the tread. Wet braking adherence performance being a very important element, this trade-off may not be acceptable.

Therefore, to improve wear rate it may be desirous to propose a novel way to increase CSR that would not result in a loss of wet braking adherence performance.

### SUMMARY OF THE INVENTION

The invention provides for a heavy truck tire tread having a longitudinal direction, a transverse direction and a thickness direction, said tread having a ground-engaging surface and comprising a series of similar tread features repeated along its longitudinal direction, each said tread feature of said series comprising:
two ducts extending from the ground-engaging surface in the thickness direction, said ducts being apart one from the other and having a duct section area of at least 10 mm² and a length comprised between 50% and 100% of a thickness of said tread;
one void being in fluidic connection with said two ducts, said void extending substantially parallel to the ground-engaging surface of the tread and at a distance therefrom and having a void section area of at least 10 mm²; and
one sipe joining said two ducts and said void;
wherein said tread feature is otherwise blind and said series comprises at least 50 of said similar tread features.

In a preferred embodiment, said series comprises at least 100 of said similar tread features.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 is a top view of a portion of a truck tire tread in accordance with the known prior art.

FIG. 2 is a perspective view of a full tread attached to a truck tire in accordance with the known prior art.

FIG. 3 is a top perspective view of a portion of a truck tire tread in accordance with a first embodiment of the invention.

FIG. 4 is a perspective view showing an inventive detail of the truck tire tread in accordance with a first embodiment of the invention.

FIG. 5 is a perspective transparent view showing the tread detail shown in FIG. 4 where normally-hidden under-surface features are made fully visible.

FIG. 6 is a top perspective view similar to FIG. 3 showing a portion of a truck tire tread in accordance with a second embodiment of the invention.

FIG. 7 is a perspective view of a mold element being used during a tire molding process to form a tire tread according to a third embodiment of the invention.

FIG. 8 is a perspective view of a full tread attached to a truck tire according to the first embodiment of the invention.

### DETAILED DESCRIPTION OF PARTICULAR EMBODIMENTS

Embodiments of the invention comprise a tire tread, and a tire including the tire tread, where the tire tread has a series of similar specific tread features repeated along its longitudinal direction. Specific embodiments, exemplary of the invention, are further described in association with the figures included herewith. It is appreciated that the inventive tire tread may comprise any tire tread for use in forming a tire. For example, the tire tread may be an original tread formed with a new tire, or may be applied to a used tire during retreading operations.

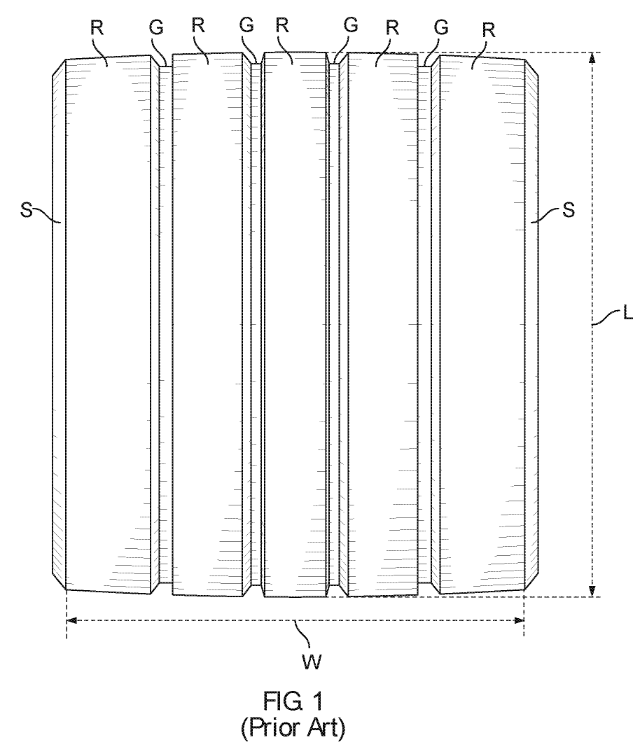

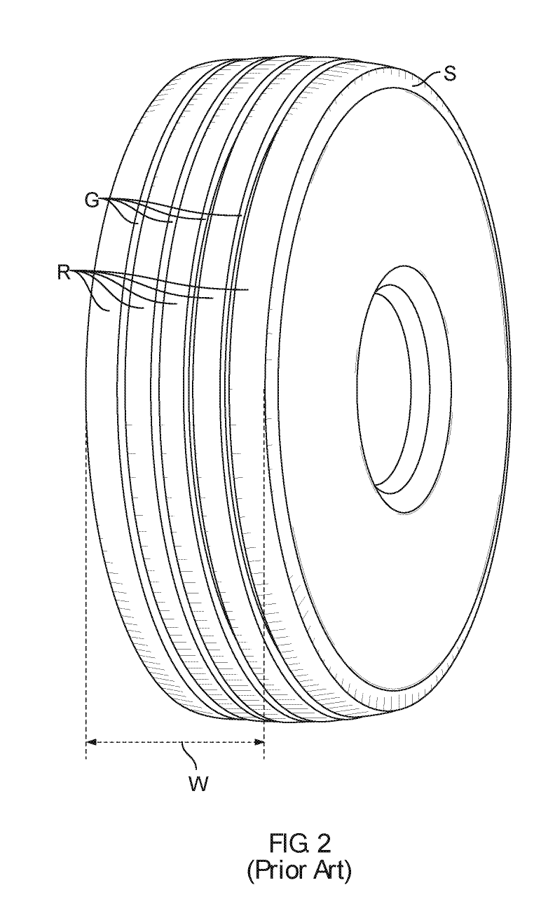

FIGS. 1-2 show a heavy truck tire tread of the known prior art. Such a tread includes a length configured to extend annularly around a tire and a width extending in a direction transverse to the length. The tread length extends in a direction which is also referred to as a lengthwise or longitudinal direction L of the tread. The tread width extends in a transverse direction W which is perpendicular to the longitudinal direction L of the tread. The transverse direction of the tread is also referred to as a lateral or widthwise direction of the tread. The tire tread also includes a pair of opposing lateral sides S spaced apart in the transverse direction to define the tread width. The pair of opposing lateral sides can be described as comprising a first lateral side and a second lateral side. The tire tread also includes an outer, ground-engaging side extending between the pair of opposing lateral sides.

As shown also in FIGS. 1-2, a heavy truck tire tread according to the known prior art includes longitudinal grooves G intended to allow water to escape from the contact patch when the tire is rolling on a wet road surface. A groove is the space formed in a tread between walls of material over a depth at most equal to the thickness of the tread, these walls of material not coming into contact with one another in the usual running conditions of the tire. Longitudinal grooves are typically between 5 and 15 mm in width. Adjacent each longitudinal groove are ribs R that constitute together the ground-engaging surface of the tread. In free-rolling tire treads (so called steer and trailer wheel positions), especially for long haul trucks, ribs are essentially continuous along the tire circumference. Additional molded features like sipes (not shown on the drawings) may also be present in some or in all of the ribs and appear at the ground-engaging surface of the tread. A sipe is the space formed in a tread between walls of material over a depth at most equal to the thickness of the tread, the said walls being able, at least in part, to come into contact with one another in the usual running conditions of the tire. Sipes are generally made as thin as manufacturing would reasonably allow, being most of the time under 1 mm and preferably under 0.5 mm.

In free-rolling tire treads, the exact Contact Surface Ratio (CSR) is mostly depending upon the number and the width of the longitudinal grooves. Free-rolling tire treads have at least three such grooves with most of those treads having a number of four grooves. CSR values typically range from 0.7 to 0.8 in this tire segment. An example of such a tire is the commercially available Michelin XZA3 275/80 R22.5. This tire has 4 grooves and it has a CSR of 0.78.

The tread also includes a thickness extending from the outer, ground-engaging side to a bottom side of the tread. The thickness extends in a direction perpendicular to the ground-engaging surface. The tread bottom side is configured to engage a tire when the tread is attached to the tire. Most commonly, the bottom side is bonded to the tire, but there are other ways to attach a tread to a tire that may be employed to attach the inventive tread to a tire.

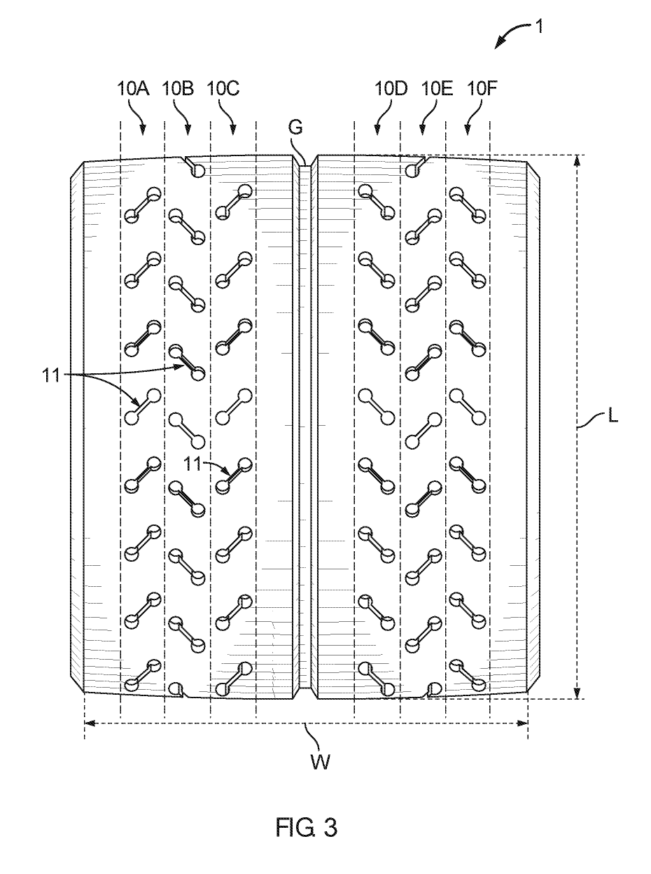

As shown in FIG. 3, a first embodiment of the inventive tread 1 comprises several series of similar tread features 11. In each series, those tread features are repeated along the longitudinal direction of the tread. In the shown embodiment, there are six series (10A, 10B, 10C, 10D, 10E, 10F) arranged parallel to one another across the width of the tread. In turn, this tread comprise only one longitudinal groove G compared to the four grooves present in the prior art tread of FIG. 1.

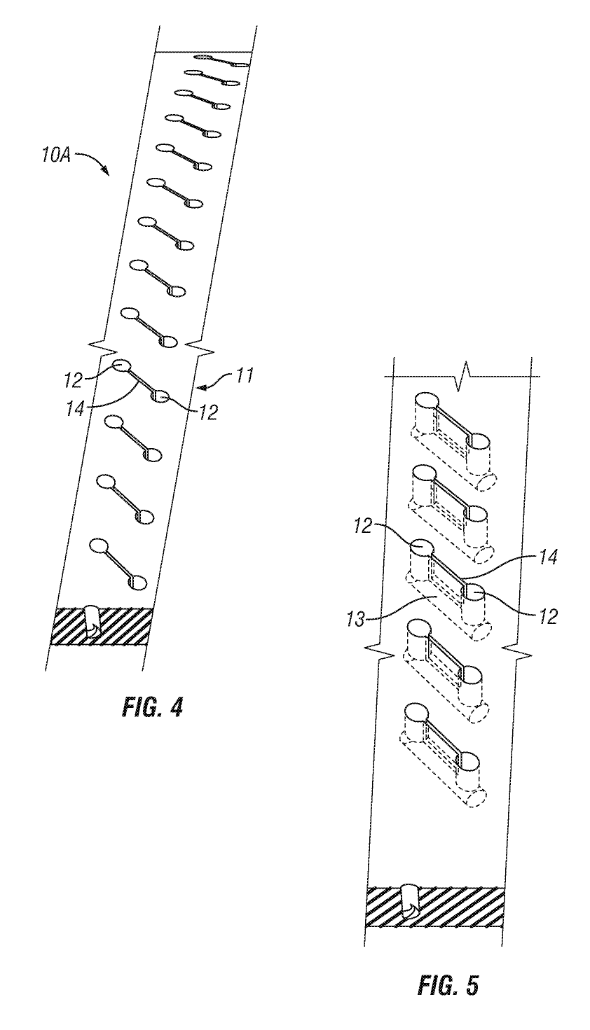

FIG. 4-5 show in more detail the tread features of one of the series. Each of said tread features comprise two ducts 12 extending from the ground-engaging surface in the thickness direction. Each of said tread features also comprises a common void 13 (only visible on the transparent view of FIG. 5) running under the ground-engaging surface of the tread. The two ducts are connected to respective ends of said void. Each of said tread features further comprises a sipe 14. The sipe joins the ground-engaging surface of the tread with said void and said two ducts.

As shown in FIG. 3-5, the two ducts of each feature are preferably offset in the longitudinal and transverse directions of the tread. Preferably the distance between the two ducts is at least equal to 4 mm.

As clearly visible form FIG. 3, each feature in each series is blind, that is to say the individual tread features are not in fluidic connection with the center groove G or the tread sides S and also not in fluidic connection with another tread feature be it from the same series or from a neighboring series.

The CSR of such a tread is therefore greatly increased. For example, the tread as shown on FIG. 3 has a CSR of 0.89. Despite this high CSR value, the wet braking adherence performance is maintained at a level similar to that of the prior art tread.

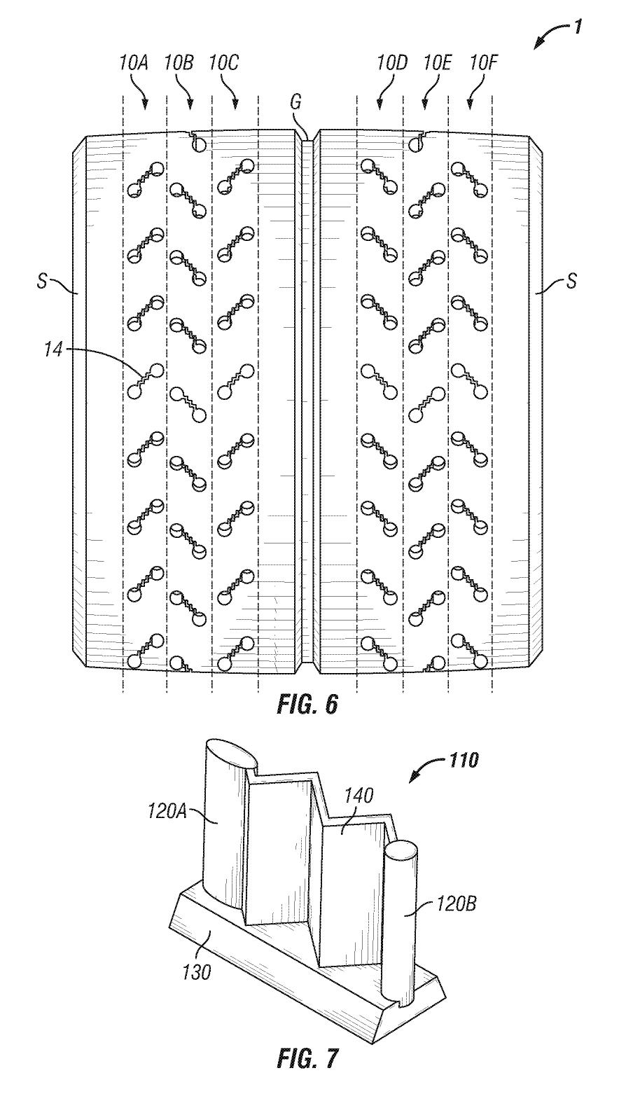

In a second embodiment of the invention shown on FIG. 6, the sipes may have an undulated shape. Undulated sipes are known to promote tread stiffness due to the sipe walls interlocking. Undulations may have many different shapes and can typically be one-directional (so called zigzag sipes) or bi-directional (so called egg-crate sipes).

FIG. 7 shows a molding element that can be used in a mold used for molding a third embodiment of the inventive tread. Because it shows the negative form or the specific tread feature of the invention, it may help better understanding its spirit. The molding element 110 comprises two pins 120a and 120B, intended to form the ducts 12. A lug 130 joining the two pins is intended to form the connecting void 13. A one-direction undulated (zigzag) blade 140 joins the lug and the pins and will form the sipe 14 in the tread. Such a molding element 110 will be repeated many times in the mold. Those repetitions need to be aligned together along the longitudinal direction of the tread to form one series of tread features characteristic of the invention and more preferably form several of those series across the tread.

FIG. 7 also serves to show that the void and ducts may have many different shapes as long as they can provide a sufficient fluid passage from one duct to the other duct of each such tread feature. Their sections may also vary along their length, provided their section area remain at least equal to 10 mm² and preferably between 12.6 mm² and 78.6 mm² which correspond to a diameter of between 4 mm and 10 mm in the case of sections of circular shape.

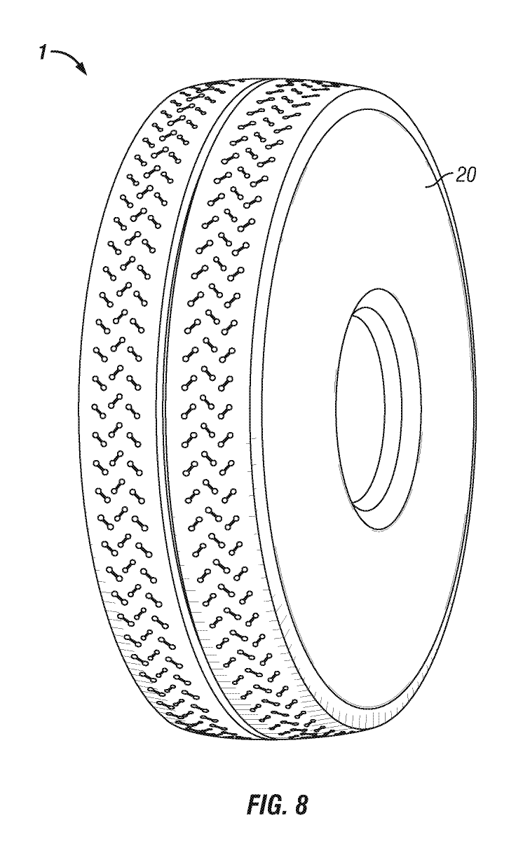

In an exemplary embodiment of the inventive tire tread shown in FIG. 8, a tread 1 is shown attached to a tire 20. It is appreciated that the tire may comprise any known tire, which may comprise any pneumatic or non-pneumatic tire. Additionally, for any such tire, the tread may be attached using any known manner. For example, in particular instances, the tire tread may be: (1) bonded to the tire by vulcanization; (2) attached using an adhesive; and/or, (3) even using mechanical means. It is appreciated that in different instances, the tire tread is either an original tread attached to a new tire or a replacement tread for use in forming a retreaded tire. The tread shown here is similar to the tread of FIG. 3 having one longitudinal groove G in the center and three series of tread features on each side of the center groove.

Many other combinations of numbers of series of such tread features and numbers or sizes of grooves can be contemplated once it is understood that the invention allows for higher CSR values with no wet adherence performance loss.

While this invention has been described with reference to particular embodiments thereof, it shall be understood that such description is by way of illustration and not by way of limitation. Accordingly, the scope and content of the invention are to be defined only by the terms of the appended claims.

1. A heavy truck tire tread having a longitudinal direction, a transverse direction and a thickness direction, said tread having a ground-engaging surface and comprising a series of similar tread features repeated along its longitudinal direction, each said tread feature of said series comprising:
two ducts extending from the ground-engaging surface in the thickness direction, said ducts being apart one from the other and having a duct section area of at least 10 mm² and a length comprised between 50% and 100% of a thickness of said tread;
one void being in fluidic connection with said two ducts, said void extending substantially parallel to the ground-engaging surface of the tread and at a distance therefrom and having a void section area of at least 10 mm²; and
one sipe joining said two ducts and said void;
wherein said tread feature is otherwise blind and said series comprises at least 50 of said similar tread features.

2. The heavy truck tire tread of claim 1 wherein the two ducts of said tread feature are apart by a distance at least equal to 4 mm.

3. The heavy truck tire tread of claim 2 wherein the two ducts have a duct section area at least equal to 12.6 mm² and at most equal to 78.6 mm².

4. The heavy truck tire tread of claim 1 wherein the void has a void section area at least equal to 12.6 mm² and at most equal to 78.6 mm².

5. The heavy truck tire tread of claim 1 wherein the tread features of said series are such that the two ducts of each feature are offset in the longitudinal direction of the tread.

6. The heavy truck tire tread of claim 5 wherein the tread features of said series are such that the two ducts of each feature are offset in the transverse direction of the tread.

7. The heavy truck tire tread of claim 1 wherein the tread features of said series are such that the sipe of each feature is undulated.

8. The heavy truck tire tread of claim 1 comprising a plurality of said series of said tread features across the width direction of the tread, said series being arranged parallel one to the other.

9. The heavy truck tire tread of claim 8 comprising at least four series of said tread features arranged parallel one to the other.

10. The heavy truck tire tread of claim 8 comprising at least six series of said tread features arranged parallel one to the other.

11. The heavy truck tire tread of claim 1 comprising less than three longitudinal open groves.

12. The heavy truck tire tread of claim 11 comprising less than two longitudinal open groves.

13. The heavy truck tire tread of claim 11 not comprising any longitudinal open grove.

14. A heavy truck tire tread of claim 1 being operably attached to a heavy truck tire.

15. A heavy truck tire comprising a heavy truck tire tread of claim 1.
